(19) United States
(12) Patent Application Publication
(10) Pub. No.: US 2008/0164838 A1
(43) Pub. Date: Jul. 10, 2008

(54) POWER CIRCUIT AND METHOD

(76) Inventor: Michael J. Maher, Pacific, MO (US)

Correspondence Address: ADVANCE PATENT SERVICES;C/O ELIAS P.SOUPOS, 5351 N. EAST RIVER RD. #103, CHICAGO, IL, 60656, US

(21) Appl. No.: 11/620,044

(22) Filed: Jan. 4, 2007

(51) Int. Cl. H02J 7/00

(52) U.S. Cl. 320/108

(57) ABSTRACT

A power circuit (102) for producing a trickle charge for a power storage device (219) in association with a electronic device includes at least one inductive element (201) having a first coil (203) that is made of a conductive material and has a first set of terminals (209), and a second coil (205) that is made of a conductive material and has a second set of terminals (213). An antenna (211) is operably connected to the first set of terminals (209) of the first coil (203). A rectifier (217) is operably connected to the second set of terminals (213) of the second coil (205). The rectifier (217) has a set of output terminals (217C and 217D), and a power storage device (219) is connected to the set of output terminals (217C and 217D) of the rectifier (217). Radiation from the environment (108) is capable of being sensed by the antenna (211) and transformed into a charging voltage for the power storage device (219).

### FIELD OF THE INVENTION

This invention relates to electronic circuits, including but not limited to wireless power circuits for charging power storage devices.

### BACKGROUND OF THE INVENTION

Wireless sensors and networks created therewith have desirable industrial applicability. Most known wireless sensors use power storage devices, or batteries, to store energy. This stored energy is used by the sensor to operate, and when exhausted, requires replenishment. A typical sensor will require periodic replacement or replenishment of its power storage device.

Some wireless devices are arranged to have a remotely charged power storage device. Such devices, for example the sensors described in U.S. Pat. No. 6,888,459, issued on May 3, 2005 to Stilp, which is incorporated herein in its entirety by reference, describes a security system that contains an RFID reader with means for transferring power thereto for the purpose of charging a battery, may use a specific radio frequency wave signal for periodically receiving an energy input that charges their power storage device. Such sensors are useful but are also limited in applications where a wireless power transmitter is available.

Information from such sensors can be wirelessly transmitted to a receiver. Intelligent devices that are capable of transmitting data over a distance without wire are known. Common examples include, for example, two-way radios that are capable of moving voice or audio analog signals electronically. Cell-phone, pagers, GPS, etc. move digital data electronically. There are myriads of applications in various configurations.

Accordingly, there is a need for a more autonomous wireless sensor that does not require a replaceable power source, is compact, and that is able to operate in any environment without the necessity of either central power transmission for charging a battery thereof, or, a need to replace a battery thereof periodically.

### SUMMARY OF THE INVENTION

A power circuit for producing a trickle charge for a power storage device in association with a electronic device includes at least one inductive element having a first coil that is made of a conductive material and has a first set of terminals, and a second coil that is made of a conductive material and has a second set of terminals. An antenna operably connected to the first set of terminals of the first coil. A rectifier operably connected to the second set of terminals of the second coil. The rectifier has a set of output terminals, and a power storage device is connected to the set of output terminals of the rectifier. Radiation from the environment is capable of being sensed by the antenna, and transformed into a charging voltage for the power storage device.

### BRIEF DESCRIPTION OF THE DRAWINGS

FIG. 1 is a block diagram of a wireless sensor system that includes a plurality of sensors, each having a power circuit in accordance with the invention.

FIG. 2 is one embodiment of a charging circuit in accordance with the invention.

FIG. 3 is an alternate embodiment of a plurality of inductive elements in accordance with the invention.

FIG. 4 is a block diagram of a sensor having a charging circuit in accordance with the invention.

FIG. 5 is a flowchart for a method of charging a power storage device in accordance with the invention.

### DESCRIPTION OF A PREFERRED EMBODIMENT

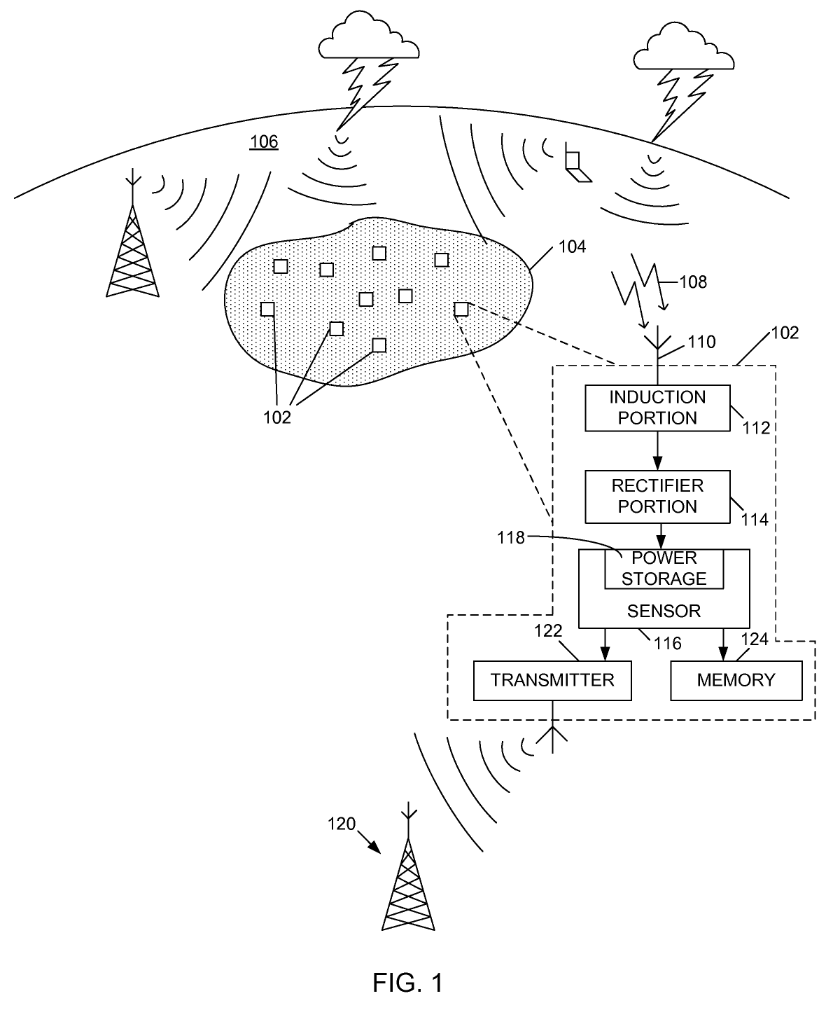

The following describes an apparatus for and method of using a power circuit to charge a power storage device of a wireless and autonomous electronic device through exploitation of electromagnetic energy that is present in the environment and that is not sent to the power circuit from a transmitter. A block diagram of a wireless sensor system 100 is shown in FIG. 1. A plurality of sensors 102 is distributed over an area 104. The area 104 may be part of an industrial complex, or may by an open field for which a certain aspect, for example motion detection, is desired. Each of the sensors 102 may be arranged in a pattern, or may alternatively be strewn across the area 104 in a random fashion. An airspace 106 of the area 104 that is close to each of the sensors 102 individually and collectively may contain, at times, waves of electromagnetic radiation 108. These waves 108 may be waves coming from remote sources, for example cellular phone communication towers, television transmission antennas, radio antennas, cellular phones, lightning strikes, and so forth. The waves 108 may comprise of many different electromagnetic signals having many various frequencies and intensities. The waves 108 may change depending on the location of the area 104.

Each of the sensors 102 includes an antenna portion 110, an inductance portion 112, a rectifier portion 114, and a sensor portion 116. The antenna portion 110 may be used to capture some of the waves 108 as the waves 108 pass over each sensor 102. Energy from the waves 108 captured by the antenna portion 110 may be communicated to the inductance portion 112 for transformation into electrical energy. The electrical energy from the inductance portion 112 is transferred to the rectifier portion 114 where its voltage is adjusted and normalized. The voltage from the rectifier portion 114 is transferred to the sensor portion 116. The sensor portion 116 includes a power storage device 118 operably connected directly to the rectifier portion 114. The sensor portion 116 uses electrical energy from the power storage device 118 to operate. The electrical voltage from the rectifier portion 114 advantageously charges the power storage device 118 continuously, or as required, to ensure proper operation of the sensor 116. Information sensed by the sensor portion 116 is advantageously transmitted to a receiver 120 through an antenna 122 integrated with the sensor 116. Alternatively, information may be stored in the sensor 116 by use of a memory portion 124 for later retrieval or transmission.

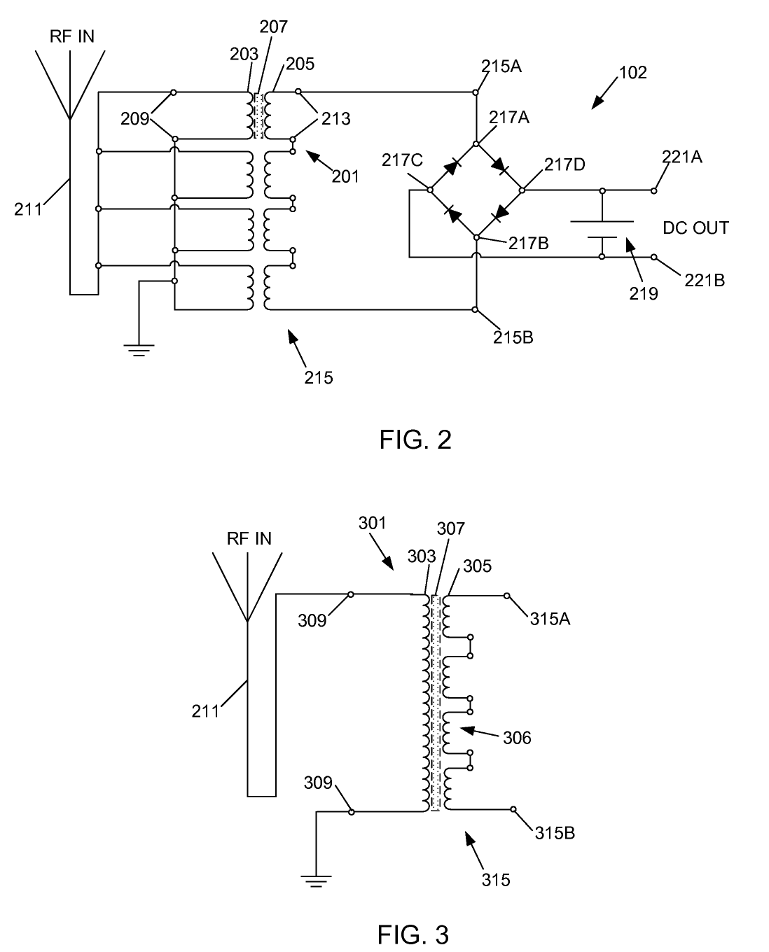

A block diagram of one of the plurality of sensors 102 is shown in FIG. 2. A sensor 200 includes at least one induction element 201. In this embodiment the sensor 200 includes four (4) induction elements 201. Each induction element 201 functions as a transformer having a first coil 203, a second coil 205, and an optional core 207, the core 207 shown in dotted line. As is known, transformers may use cores to improve their efficiency, but the cores are not required for operation. The first coil 203 has a first set of terminals 209 that are connected to each of two poles of an antenna 211. Each additional induction element 201 is similarly configured and connected, in a parallel configuration, to the antenna 211. In an alternative embodiment, additional antennas may be used to power different inductive elements. In this alternative embodiment, each additional antenna may be connected to one or more inductive elements.

The second coil 205 of the induction element 201 has a second set of terminals 213. Each induction element 201 is connected, in a series configuration, to an adjacent induction element 201. All induction elements 201, connected in series, form a charging node 215 having a positive terminal 215A and a negative terminal 215B. The positive terminal 215A and the negative terminal 215B of the charging node 215 are connected to a set of input terminals 217A and 217B of a rectifier 217. The rectifier 217, as is known, may include electrical circuit elements that are arranged to rectify, condition, and process an electrical input from the charging node 215. The rectifier 217 has a set of output terminals 217C and 217D are connected to an energy storage device 219, and to a set of sensor terminals 221 A and 221 B. The energy storage device 219 may be a rechargeable battery, but may advantageously be a capacitor.

The set of sensor terminals 221 A and 221 B are connected to a sensor assembly 221 that includes various other functional elements, such as, an accelerometer for motion detection, thermometer for temperature measurement, hygrometer for humidity measurements, and so forth, in addition to an information transmitter and/or a memory device. The sensor assembly 221 may advantageously also include a microprocessor having logic algorithms coded therein that effect operation of the device.

A charging node 315, which is an alternate embodiment of the charging node 215, is shown in FIG. 3. The charging node 315 includes a single induction element 301 having a first coil 303, a plurality of second coils 305, and a core 307. The first coil 303 is a continuous and long coil as compared to each individual first coil 203 of each of the induction elements 201 of the embodiment shown in FIG. 2. The plurality of second coils 305 includes more than one coil segments 306 that are connected in series and arranged to receive electromagnetic fluctuations from the first coil 303. The first coil 303 has a set of terminals 309 connected to the antenna (not shown), and the charging node 315 has a set of terminals 315A and 315B that are connected to a rectifier (not shown) as described for the embodiment of FIG. 2.

During operation of the sensor 102, each of the second coils 205 or 305 in each of the charging nodes 215 or 315 generates an incremental voltage difference across its terminals (for example, the terminals 213) that is added through the series configuration of the connections between each second coil 205 or 305. The combined voltage difference across the charging node 215 or 315 creates an appreciable voltage difference that is capable of producing a trickle charge for the power storage device 219 through the rectifier 217. For example, use of micro machining and conductor doping of silicone wafers, also known as nano-construction methods, can be used to populate hundreds if not thousands of induction elements 201 onto a relatively small circuit, and interconnect same to power a battery for a sensor assembly that are all integrated onto the same circuit.

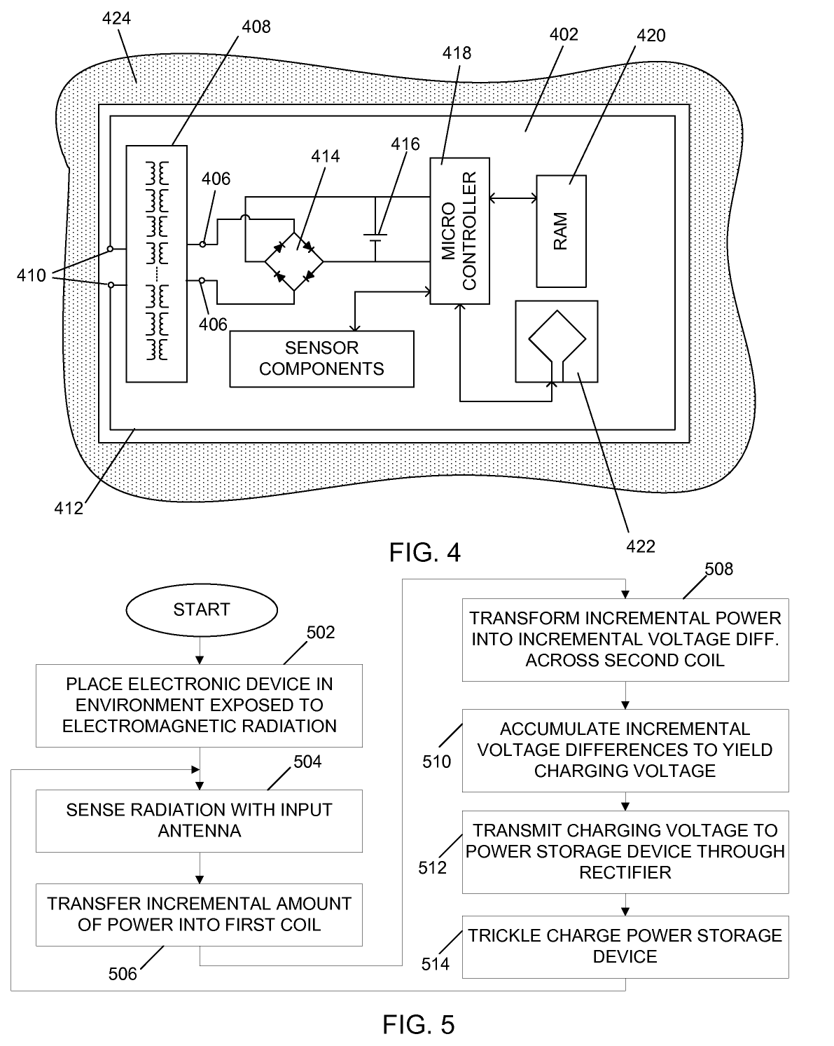

A block diagram of a sensor 400 is shown in FIG. 4. The sensor 400 is assembled and constructed onto a single silicone wafer 402 having interdigitated connections 404 that are printed or formed thereon to accomplish electrical connections between components. Each of a plurality of induction elements 405 that form a charging node 406 are imprinted and constructed in close proximity to each other on an induction section 408 of the wafer 402. An input antenna 410 may be an electrical lead 412 that is also printed onto the wafer 402. A rectifier 414, power storage device 416, microcontroller 418, memory storage device 420, and transmitter device 422, are all operably connected to each other and attached to the wafer 402. The wafer 402 may advantageously be encased in a protective layer, for example an epoxy cocoon 424, and may also have additional features for further protection, for example, a hard plastic casing, to protect the sensor 400 from the environment and to allow deployment of same through various methods, for example, aerial dispersion from an aircraft. Moreover, in an alternative embodiment the input antenna 410 may advantageously be separate from the wafer 402, coated with a protective sheath, and protrude from a casing of the sensor assembly to facilitate receipt of electromagnetic waves.

A flowchart for a method of charging a power storage device for an electronic device is shown in FIG. 5. The electronic device, which includes at least one inductive element, a rectifier, and a power storage device, is placed in an environment that is exposed to electromagnetic radiation at step 502. The electromagnetic radiation may be generated at a distant source for a different purpose, for example a television antenna emitter, a cellular phone emission antenna, and so forth. The electronic device placement of step 502 may be performed in the environment that is within range of any electromagnetic radiation from the distant source.

The electromagnetic radiation, or a portion thereof, may be sensed by an input antenna at step 504. The antenna may transfer an incremental amount of electrical power from the electromagnetic radiation into a first coil of the at least one inductive element at step 506. The first coil may transform the incremental amount of electrical power into an incremental voltage difference across a second coil at step 508. A plurality of incremental voltage differences may be accumulated across a plurality of second coils on adjacent inductive elements at step 510. The accumulated voltage differences yield a charging voltage difference, which is transmitted to a power storage device through a rectifier at step 512. The power storage device can then receive a trickle charge due to the charging voltage difference at step 514.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A power circuit for producing a trickle charge for a power storage device in association with a electronic device, the power circuit comprising:
at least one inductive element that includes a first coil that is made of a conductive material and has a first set of terminals, a second coil that is made of a conductive material and has a second set of terminals;
an antenna operably connected to the first set of terminals of the first coil;
a rectifier operably connected to the second set of terminals of the second coil;
wherein the rectifier has a set of output terminals, and wherein a power storage device is connected to the set of output terminals of the rectifier.

2. The power circuit of claim 1, further comprising an additional inductive element that includes an additional first coil that is connected to the antenna in a parallel configuration with the first element.

3. The power circuit of claim 2, wherein the additional inductive element includes an additional second coil, wherein the additional second coil is connected to the second coil in a parallel configuration.

4. The power circuit of claim 1, further comprising at least one core disposed between the first coil and the second coil of the at least one inductive element.

5. The power circuit of claim 1, wherein the power storage device is at least one of a rechargeable battery, a capacitor, and any device capable of storing electrical power.

6. An electronic device comprising:
a transformer having a first coil, and a second coil;
an additional transformer having an additional first coil, and an additional second coil;
an antenna connected in a parallel configuration to the first coil and the additional first coil;
wherein the second coil and the additional second coil are connected in series to yield a charging node, wherein a rectifier is operably connected to the charging node, and wherein a power storage device is operably connected to a set of output terminals of the rectifier.

7. The electronic device of claim 6, further comprising a core disposed between the first coil and the second coil.

8. The electronic device of claim 6, further comprising an additional core disposed between the additional first coil and the additional second coil.

9. The electronic device of claim 6, wherein the power storage device is at least one of a rechargeable battery and a capacitor.

10. The electronic device of claim 6, further comprising a microcontroller operably connected to the power storage device, and a sensor element arranged for operable communication with the microcontroller.

11. The electronic device of claim 10, further comprising an output antenna operably connected to the microcontroller.

12. The electronic device of claim 6, further comprising a protective cocoon disposed at least in part around the transformer and the additional transformer.

13. A method of charging a power storage device comprising the steps of:
placing the electronic device in an environment that is exposed to electromagnetic radiation;
sensing at least a portion of the electromagnetic radiation with an antenna that is operably associated with the electronic device;
transferring an incremental amount of electrical power from the antenna into a first coil of at least one inductive element;
transforming the incremental amount of electrical power into an incremental voltage difference across a second coil of the at least one inductive element;
accumulating a plurality of incremental voltage differences across a plurality of second coils that are connected in series to yield a charging voltage difference;
transmitting the charging voltage difference to a set of input terminals of a rectifier;
using a charging current from a set of output terminals of the rectifier to trickle charge a power storage device.

14. The method of claim 13, wherein the electromagnetic radiation has a random configuration and comprises at least one of radio signals, television signals, lightning radiation, and cellular telephone radiation.

15. The method of claim 13, further comprising the step of powering a microcontroller with electrical power from the power storage device.
